(19) United States
(12) Patent Application Publication
(10) Pub. No.: US 2025/0365048 A1
(43) Pub. Date: Nov. 27, 2025

(54) HYBRID AI/ML FOR CSI FEEDBACK ENHANCEMENT

(71) Applicant: InterDigital Patent Holdings, Inc., Wilmington, DE (US)

(72) Inventors: Mohamed Amine Arfaoui, Montreal (CA); Philip Pietraski, Jericho, NY (US); Guodong Zhang, Woodbury, NY (US); Asil Koc, Verdun (CA); John Kaewell, Jamison, PA (US)

(73) Assignee: InterDigital Patent Holdings, Inc., Wilmington, DE (US)

(21) Appl. No.: 18/674,544

(22) Filed: May 24, 2024

(51) Int. Cl. H04B 7/06; H04W 24/02

(52) U.S. Cl. CPC H04B 7/0626; H04W 24/02

(57) ABSTRACT

A wireless transmit/receive unit (WTRU) may receive configuration information. The configuration information may include channel state information (CSI) reference signal (RS) (CSI-RS) resource configuration information and/or CSI feedback reporting configuration information. The WTRU may determine a downlink (DL) CSI estimate based on one or more CSI-RSs received in accordance with the CSI-RS resource configuration information. The WTRU may generate a CSI feedback report based on a comparison between the DL CSI estimate and historical DL CSI estimates. The WTRU may send the CSI feedback report.

### BACKGROUND

Artificial intelligence (AI) may be referred to as the behavior exhibited by machines that mimic cognitive functions to sense, reason, adapt, and/or act. An AI component may refer to the realization of behaviors and/or conformance to requirements by learning based on data, without (e.g., explicit) configuration of sequence of steps of actions. Such AI component may enable learning complex behaviors which might be difficult to specify and/or implement when using legacy methods.

### SUMMARY

Embodiments described herein may enable a wireless transmit/receive unit (WTRU) to perform adaptive filtering techniques for channel state interference (CSI) feedback reporting.

A wireless transmit/receive unit (WTRU) may receive configuration information. The configuration information may include channel state information (CSI) reference signal (RS) (CSI-RS) resource configuration information and/or CSI feedback reporting configuration information. The WTRU may determine a downlink (DL) CSI estimate based on one or more CSI-RSs received in accordance with the CSI-RS resource configuration information. The WTRU may generate a CSI feedback report based on a comparison between the DL CSI estimate and historical DL CSI estimates. The WTRU may send the CSI feedback report.

The WTRU may generate content of the CSI feedback report based on a difference between the DL CSI estimate and a DL CSI estimate included in a sequence of historical DL CSI estimates at the WTRU. The CSI feedback report may include instructions on how to reconstruct the DL CSI estimate at a network node based on historical DL CSI estimates at the network node.

The comparison may include a difference between the DL CSI estimate and a DL CSI estimate comprised in a sequence of historical DL CSI estimates at the WTRU. When the difference is lower than a first threshold, the WTRU may generate the CSI feedback report such that the CSI feedback report includes a first (e.g., setup) portion that includes an indication to the network node to use a previously reconstructed DL CSI estimate included in a sequence of historical DL CSI estimates at the network node based on a sequence of historical reconstructed DL CSI estimates at the network node to configure a DL transmission.

The comparison may include a first comparison and/or a second comparison. The first comparison may include a first difference between the DL CSI estimate and a previous DL CSI estimate comprised in a sequence of historical DL CSI estimates at the WTRU. The second comparison may include a second difference between the DL CSI estimate and an output of an adaptive filter applied to a sequence of historical DL CSI estimates at the WTRU. When the first difference is greater than a first threshold, the WTRU may generate the CSI feedback report such that content of the CSI feedback report is based on the second difference. When the second difference is lower than a second threshold, the WTRU may generate the CSI feedback report such that the CSI feedback report comprises a first (e.g., setup) portion and a second (e.g., quantity) portion, where the first (e.g., setup) portion includes an indication to the network node to apply adaptive filtering to a sequence of historical reconstructed DL CSI estimates at the network node, an index of a structure of the filter in the predefined book (e.g., codebook), or one or more procedures on how to apply the adaptive filter to the sequence of historical reconstructed DL CSI estimates at the network node, and where the second (e.g., quantity) portion may include parameters of the adaptive filter. When the second difference is greater than a second threshold, the WTRU may use artificial intelligence (AI)/machine learning (ML)-based CSI feedback reporting techniques or non-AI/ML CSI feedback reporting techniques to generate the CSI feedback report.

The WTRU may determine a structure and one or more parameters of the adaptive filter to minimize a measured difference between the DL CSI estimate and a sequence of historical DL CSI estimates at the WTRU associated with the adaptive filter.

The WTRU may receive, via downlink control information (DCI) and/or a medium access control (MAC) control element (CE), activation information. The activation information may include one or more of a size of a time window, a length of a sequence of historical DL CSI estimates at the WTRU, and/or one or more thresholds to trigger an adaptive filter parameter update. The WTRU may generate the CSI feedback report based on the activation information.

The CSI feedback reporting configuration information may include a CSI-RS configuration type. The WTRU may be configured to generate the CSI feedback report based on the CSI-RS configuration type.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIGS. 2A and 2B is a diagram of an example procedure for generating and/or transmitting a channel state information (CSI) feedback report.

FIG. 3 is a diagram of an example procedure for generating and/or transmitting a CSI feedback report.

FIG. 4 depicts example WTRU and/or base station (e.g., gNB) procedures for adaptive filtering.

FIG. 5 depicts an example CsiNet model architecture.

### DETAILED DESCRIPTION

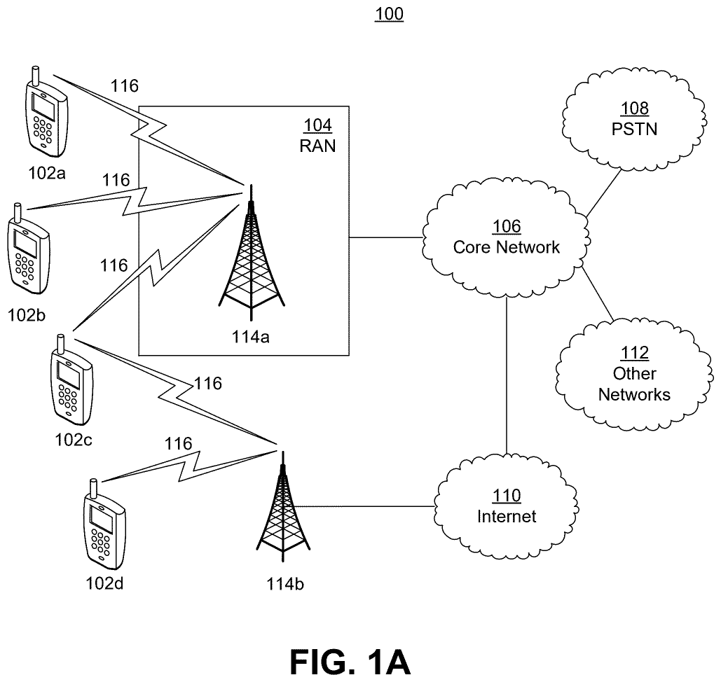

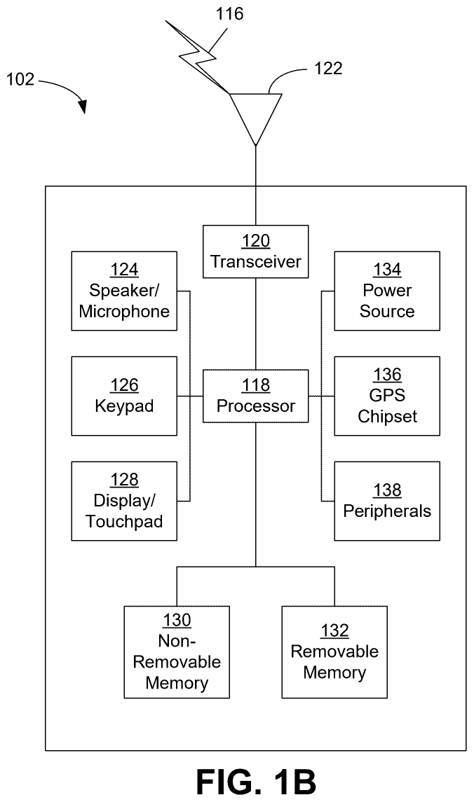

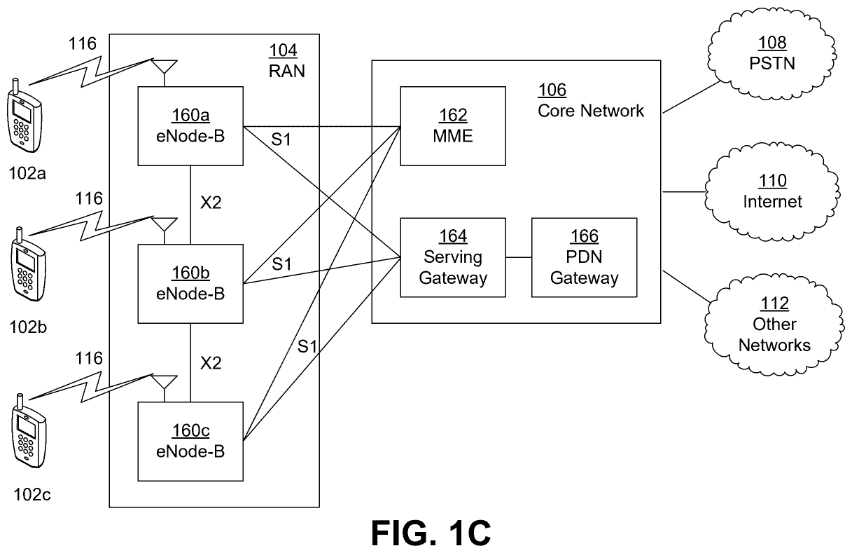

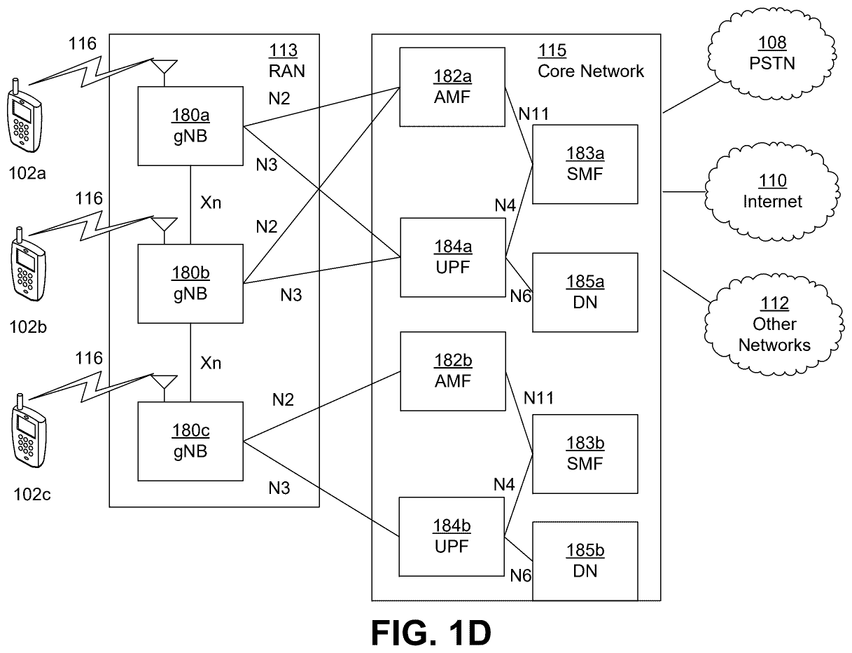

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), Single-Carrier Frequency Domain Equalization (SC-FDE), DFT-s-OFDM, and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement a radio technology such as 6G Radio Access, which may establish the air interface 116 using 6G standards.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHZ mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or one or more (e.g., any) other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

For systems using artificial intelligence (AI) and/or machine learning (ML) models for channel state feedback (CSF) functions, embodiments described herein may include methods for the WTRU to enable adaptive filtering techniques for channel state interference (CSI) feedback reporting.

Artificial intelligence (AI) may be referred to as the behavior exhibited by machines that mimic cognitive functions to sense, reason, adapt, and/or act. An AI component may refer to the realization of behaviors and/or conformance to requirements by learning based on data, without (e.g., explicit) configuration of sequence of steps of actions. Such AI component may enable learning complex behaviors which might be difficult to specify and/or implement when using legacy methods.

Machine learning (ML) may refer to the type of algorithms that solve a problem based on learning through experience (e.g., data), without being (e.g., explicitly) programmed (e.g., configuring a set of rules). ML can be considered as a subset of AI. Different ML paradigms may be envisioned based on the nature of data and/or feedback available to the learning algorithm. In examples, a supervised learning approach may include learning a function that maps input to an output based on labeled training example, where each training example may be a pair including of an input and/or its corresponding output. In examples, an unsupervised learning approach may include detecting patterns in the data with no pre-existing labels. In examples, a reinforcement learning approach may include performing sequence of actions in an environment to maximize the cumulative reward. In examples, it may be possible to apply ML algorithms using a combination and/or interpolation of the approaches mentioned herein. For example, a semi-supervised learning approach may use a combination of a small amount of labeled data with a large amount of unlabeled data during training. In this regard, semi-supervised learning may fall between unsupervised learning (e.g., with no labeled training data) and supervised learning (e.g., with only labeled training data).

Deep learning may refer to a class of ML algorithms that employ artificial neural networks, specifically, Deep Neural Networks (DNNs), which may have been loosely inspired from biological systems. The DNNs may be a special class of ML models that are inspired by the human brain, where the input is linearly transformed and/or pass through non-linear activation function one or more (e.g., multiple) times. DNNs may include one or more (e.g., multiple) layers where each layer may include linear transformation and/or a given non-linear activation functions. The DNNs can be trained using the training data via back-propagation algorithm. DNNs may show state-of-the-art performance in one or more (e.g., a variety of) domains (e.g., speech, vision, natural language, wireless communication, etc.), and/or for one or more (e.g., various) ML settings (e.g., supervised, un-supervised, semi-supervised, etc.).

Auto-encoders (AE) may be a specific class of deep neural networks (DNNs) that arise in the context of unsupervised machine learning setting, where the high-dimensional data is non-linearly transformed to a lower dimensional latent vector using the DNN based encoder and/or the lower dimensional latent vector is used to reconstruct the high-dimensional data using a non-linear decoder. The encoder may be represented as E(x; Wₑ), where x is the high-dimensional data and/or Wₑ may represent the parameters of the encoder. The decoder may be represented as D(z; W_{d}), where z is the low-dimensional latent representation and/or W_{d} may represent the parameters of the decoder. Using training data {x₁, . . . , x_{N}}, the auto-encoder can be trained by solving the following optimization problem:

$$\{ {W}_{e}^{tr} , {W}_{d}^{tr} \} = arg {min}_{{W}_{e} , {W}_{d}} {\sum }_{i = 1}^{N} {‖ {x}_{i} - D ( E ( {x}_{i} ; {W}_{e} ) ; {W}_{d} ) ‖}_{2}^{2} .$$

The optimization problem can be (e.g., approximately) solved using backpropagation algorithm. The trained encoder

$$E ( x ; {W}_{e}^{tr} )$$

can be used to compress the high-dimensional data and/or the trained decoder

$$D ( z ; {W}_{d}^{tr} )$$

can be used to reconstruct the high-dimensional data from the latent representation.

Channel state feedback (CSF) functions may refer to a series of functions implemented at the WTRU side to enable the estimation of the CSI and/or its transmission to the network (NW). By doing so, the NW can exploit the received CSI feedback to apply one or more (e.g., some) link adaptation functions to the WTRU (e.g., appropriate modulation and coding scheme (MCS) and/or precoding, beam management, power allocation, resource block (RB) allocation, etc.) The CSF functions may include the CSI estimation, from which the WTRU can generate a CSI feedback report that includes one or more (e.g., some) measurements indicators of the channel quality (e.g., channel quality indicator (CQI), precoding matrix indicator (PMI), rank indicator (RI), and/or layer indicator (LI), etc.). CSF functions may be extended to include CSI prediction, CSI compression, as well as one or more combinations between these functions. The details of these CSF functions may be provided herein.

Mechanisms and/or frameworks for using AI/ML based approaches at the air interface level may be described herein. One or more (e.g., two) (sub)-use case, may include spatial/frequency (SF) CSI compression and/or temporal CSI prediction. SF CSI compression may refer to the operation of compressing the CSI estimates in the SF domain by the WTRU (e.g., using AEs described herein) to a quantized-binary representation with a predefined feedback size (e.g., in bits) and/or transmitting it to the NW. The NW may reconstruct the SF CSI estimates by decompressing the received CSI feedback from the WTRU. Temporal CSI prediction may refer to the operation of predicting posterior SF CSI, (e.g., either) by the WTRU and/or by the NW, from historical SF CSI estimates. The two sub-use cases may be within the CSF functions and/or may be implemented after the CSI estimation function.

Mechanisms and frameworks for using AI/ML based approaches at the air interface level may include temporal/spatial/frequency (TSF) CSI compression, CSI compression plus prediction, and/or joint CSI compression and/or prediction. TSF CSI compression may refer to the operation of generating a quantized-binary representation of the CSI with a predefined feedback size (e.g., in bits) based on the current and the prior SF CSI estimates, and transmitting it to the NW. The NW may reconstruct the current SF CSI estimates by jointly incorporating the reconstructed prior SF CSI estimates and the received CSI feedback from the WTRU. CSI compression plus prediction may refer to the operation of concatenating the SF/TSF CSI compression and the temporal CSI prediction operation in a cascaded manner. The order of concatenation (e.g., compression first or prediction first may be interchangeable). Joint CSI compression and prediction may refer to the operation of jointly performing CSI compression and prediction within a single function block. For example, joint CSI compression and prediction may refer to the operation of generating a quantized-binary representation of the CSI with a predefined feedback size (e.g., in bits) based on the current and the prior SF CSI estimates, and transmitting it to the NW. The NW may reconstruct the posterior SF CSI estimates by jointly incorporating the reconstructed prior SF CSI estimates and the received CSI feedback from the WTRU.

Wireless devices may (e.g., need to) adapt to their local environmental conditions (e.g., radio propagation environment). To adapt, wireless devices may know channel state information (CSI) at (e.g., both) transmitting and/or receiving nodes so that the transmission can be (e.g., properly) configured and/or received. CSI may be used at the transmitter to select MCS, layers, precoder, power, RB allocation, etc. CSI may be used at the receiver (e.g., explicitly and/or implicitly) for demodulation. CSI may be obtained by a non-AI/ML algorithm (e.g., channel estimator, predictor, compressor) that uses the output of other non-AI/ML algorithms (e.g., Doppler estimator) to estimate, predict, and/or provide other channel related statistics. AI/ML can be used to learn channel state feedback (CSF) functions (e.g., estimator, predictor, compressor, etc.). AI/ML embodiments for CSI feedback functions may use trained (e.g., static) AI/ML models, and/or AI/ML models that may be periodically finetuned and/or retrained on relatively long timescales. Compared to time-varying adaptive filters (E.g., the Kalman Filter for CSI prediction), for example, AI/ML embodiments may be less able to adapt to channels with time-varying statistics, may be less able to predict with limited historical information, and/or may require high complexity since there may be no mechanism to adapt the AI/ML on (e.g., very) short timescales. To address this, embodiments described herein may take advantage of the channel statistics of historical CSI estimates.

Embodiments described herein may relate to methods for hybrid AI/ML for CSI feedback enhancements. Since historical information may be retained at the receiver of CSI feedback (e.g., AI/ML model outputs), rather than sending one or more (e.g., multiple) downlink (DL) CSI estimates (and/or compressed/predicted versions thereof), the WTRU may send instructions to the gNB for how to reconstruct a current DL CSI estimate from the historical DL CSI estimates. In examples, these instructions can be a set of parameters of a pre-agreed function and/or filter. An adaptative filter may be combined with a static and/or a semi-static AI/ML model for CSI compression and/or prediction. Embodiments described herein the filter being an AI/ML model and/or the signaled parameters may be the parameters of the model. Embodiments described herein may include methods, and/or procedures for determining such adaptive filter at the WTRU and/or for generating the associated CSI feedback report that includes the adaptive filter along with the instructions on how to reconstruct the CSI at the gNB from the historical reconstructed DL CSI estimates at the gNB. Embodiments described herein may be applicable to temporal/spatial/frequency (TSF) CSI compression and/or to joint CSI compression and prediction. CSI estimates can be (e.g., either) the estimated DL raw channel matrices and/or the eigenvectors associated to the estimated raw channel matrices. Embodiments described herein may be applicable to both types of CSI. For example, embodiments described herein may be applicable to one or more (e.g., any) type of transmitting and/or receiving node(s), including wireless transmit/receive unit (WTRU) and/or network node(s), WTRUs using sidelink, and/or WTRU-to-WTRU direct communication.

The current DL CSI estimate at the WTRU may be referred to as the instantaneous estimated DL CSI at the WTRU upon the reception of CSI-RS. The current DL CSI estimate at the WTRU may be denoted by H.

The sequence of historical DL CSI estimates at the WTRU may be referred to as a sequence that includes the historical DL CSI estimates at the WTRU prior to the current DL CSI estimate H, that have been reported back to the gNB. The sequence of historical DL CSI estimates at the WTRU may be denoted by Hₛ.

The current reconstructed DL CSI estimate at the gNB may be referred to as the reconstructed DL CSI estimate at the gNB from the CSI feedback report transmitted by the WTRU that is associated to the current DL CSI estimate H at the WTRU. The current reconstructed DL CSI estimate at the gNB is denoted by Ĥ.

The sequence of historical reconstructed DL CSI estimates at the gNB may be referred as a sequence that includes the historical reconstructed DL CSI estimates at the gNB, prior to the current reconstructed DL CSI estimate Ĥ, from the prior CSI feedback reports transmitted by the WTRU that are associated to the historical DL CSI estimates at the WTRU in the sequence Hₛ. The sequence of historical reconstructed DL CSI estimates at the gNB may be denoted by Ĥₛ.

A WTRU may receive configuration information. The WTRU may receive configuration information from the gNB for one or more of the following. For example, the WTRU may be configured dynamically with the first and/or second thresholds (e.g., as described herein). For each CSI feedback reporting triggering, the WTRU may receive the threshold(s) configuration, and/or other configuration information (e.g., from the network (NW) through DCI and/or MAC-CE). The configuration information may include CSI-RS resource configuration information, CSI feedback reporting configuration information, and/or threshold(s) configuration. The one or more (e.g., two) thresholds may be different, and/or the threshold(s) may be configured dynamically by the NW. For example, the WTRU may receive CSI-RS resource configurations, which may include the CSI-RS periodicity, location, density, etc. The WTRU may receive CSI feedback reporting configuration. For example, CSI feedback reporting configuration may include (e.g., CSI-RS) reporting/configuration type (e.g., periodic, semi-persistent, and/or aperiodic), report quantity (e.g., configuration of AI/ML based CSI feedback report), and/or configuration of channel state feedback (CSF) parameters. CSF parameters may include value of time window and/or one or more (e.g., a number of) CSI estimates used for CSF, threshold(s) to trigger CSF filter parameter update, etc.

A WTRU may receive CSI-RS according to the configuration (e.g., as described herein).

A WTRU may estimate the current DL CSI (e.g., H), based on the received CSI-RS. For example, the WTRU may determine a DL CSI estimate based on one or more CSI-RSs received in accordance with the CSI resource configuration information.

A WTRU may apply AI/ML-based techniques for CSI feedback reporting. For example, the WTRU may apply (e.g., as described herein) Spatial/Frequency (SF) CSI Compression and/or Temporal/Spatial/Frequency (TSF) CSI compression.

One or more (e.g., two) methods for the WTRU to start applying CSF configuration may be described herein. A first method may include no additional activation (e.g., needed) after radio resource control (RRC) configurations. A second method may include a WTRU that receives an activation of adaptive filter-based CSF. For example, the WTRU may receive the activation of adaptive filter-based CSF dynamically (e.g., via downlink control information (DCI) and/or medium access control (MAC) control element (CE) (MAC CE). The WTRU may receive, via DCI and/or MAC CE, an indication to activate filtering associated with the difference. The indication to activate may include activation information. The activation information may include one or more of a size of a time window, a length of a sequence of historical DL CSI estimates at the WTRU, and/or one or more thresholds to trigger an adaptive filter parameter update. The WTRU may generate the CSI feedback report based on the activation information. For example, the processor of a WTRU may be configured to generate the CSI feedback report based on the activation information. The gNB may determine to activate the adaptive filter-based CSF based on the performance feedback from the WTRU to the gNG (e.g., block error rate (BLER), number of acknowledgements (ACK) and/or negative ACK (NACK)) that are associated to the historical DL CSI estimates. The activation may include the size of the time window (e.g., number of DL time slots), the length of the sequence Hₛ of historical DL CSI estimates at the WTRU, and/or one or more thresholds to trigger CSF filter parameter update, etc. The threshold(s) may be based on the metric used to quantify the measured difference. For example, as described herein, if the measured difference is mean-squared error (MSE), the first threshold can be equal to −5.5 (in the log 10 scale) and the second threshold can be equal to −4.5 (in the log 10 scale).

A WTRU may store the historical DL CSI estimates. For example, the WTRU may store the historical DL CSI estimates, that have been reported back to the gNB over a time window, into a sequence of historical DL CSI estimates Hₛ, and/or may use the historical DL CSI estimates for CSI feedback reporting (e.g., upon receiving the activation).

The gNB may store the historical reconstructed DL CSI estimates that have been reconstructed based on the prior CSI feedback reports that are associated to the sequence Hₛ of historical DL CSI estimates at the WTRU, into a sequence of historical reconstructed DL CSI estimates Ĥₛ.

A WTRU may generate a CSI feedback report to the gNB. The WTRU may generate the CSI feedback report based on activation information (e.g., as described herein). The WTRU may generate the CSI feedback report based on a comparison between a DL CSI estimate and historical DL CSI estimates. For example, the WTRU may generate the CSI feedback report based on a difference between a DL CSI estimate and a DL CSI estimate included in a sequence of historical DL CSI estimates (e.g., at the WTRU). For example, the WTRU may generate the CSI feedback report based on a difference between the DL CSI estimate(s) and filtered DL CSI estimates (e.g., the output of a filter applied to the historical DL CSI estimates). For example, the WTRU may generate the CSI feedback report based on the CSI-RS configuration type (e.g., periodic, semi-persistent, and/or aperiodic). The CSI feedback report may include one or more of the following. The CSI feedback report may include an explicit and/or a modified (e.g., compressed) representation of the combination between the current DL CSI estimate H and the sequence of historical DL CSI estimates Hₛ. The CSI feedback report may include instructions on how to reconstruct the current DL CSI estimate at the gNB based on the sequence Ĥₛ of historical reconstructed DL CSI estimates at the gNB (e.g., an adaptive filter and its parameters). For example, the CSI feedback report may include instructions on how to reconstruct the DL CSI estimate at a network node based on historical DL CSI estimates at the network node. The contents of the CSI feedback report may be based on a difference between the DL CSI estimate and the most recent historical DL CSI estimate at the WTRU. For example, the WTRU may generate the content of the CSI feedback report based on a difference between the DL CSI estimate and a DL CSI estimate included in a sequence of historical DL CSI estimates at the WTRU.

The DL CSI estimates may be synchronized between a WTRU and the network. The DL CSI estimates at the WTRU may not be the same as the DL CSI estimates at the network node. For example, the WTRU may have the (e.g., exact) DL CSI estimated which are fed back to the gNB. The gNB may reconstruct the DL CSI estimates, for example, based on the feedback from the WTRU. The historical reconstructed estimates at the gNB may be equal to the historical DL CSI estimates at the WTRU plus some reconstruction error.

A WTRU may determine the structure and/or the parameters of an adaptive filter F that minimizes the measured difference between H and F(Hₛ). For example, the WTRU may determine a structure and/or one or more parameters of an adaptive filter to minimize a (e.g., measured) difference between the DL estimate and a sequence of historical DL CSI estimates at the WTRU associated with the adaptive filter. Example of parameters of the filter may include the coefficients of the filter. For example, if the filter is a finite impulse response (FIR) filter, the parameters of the filter may include the coefficients of the taps of the filter.

The structure of the filter F can be specified. For example, the structure of F can be specified in the standards and/or a book of predefined filters that are configured by RRC signaling. The gNB and/or the WTRU can select the filter to use from the configured book/list of filters. When the structure of the filter F is selected by the gNB, one or more of the following may occur. The gNB may select the structure of the filter F from a predefined book known to the WTRU. The WTRU may receive the index of the structure of the filter F in the predefined book (e.g., codebook). The WTRU may receive the index of the structure of the filter in the book in a DCI. The WTRU may determine the (e.g., optimal) parameters of the selected structure of the filter F. When the structure of the filter F is selected by the WTRU, one or more of the following may occur. The WTRU may browse the (e.g., entire) predefined book of structures of filters and/or may select a structure and/or parameters that minimizes the measured difference between H and F(Hₛ). The measured difference can be cosine similarity, mean squared error, and/or one or more (e.g., any) other metrics (e.g., the choice of the metric can be configured by the gNB).

A WTRU may compute the (e.g., measured) difference between the current DL CSI estimate H and the most recent historical DL CSI estimate in Hₛ, which may be the most recent historical DL CSI to the current DL CSI, that was estimated at the WTRU, fed back from the WTRU to the gNB, and/or (e.g., successfully) reconstructed at the gNB. For example, the WTRU may measure the difference between the DL CSI estimate and the most recent historical CSI estimate at the WTRU. For example, the WTRU may measure a difference between the DL CSI estimate and a DL CSI estimate included in a sequence of historical DL CSI estimates at the WTRU. The measured difference can be cosine similarity, mean squared error, and/or one or more (e.g., any) other metrics (e.g., the choice of the metric can be configured by the gNB).

If the measured difference between the current DL CSI estimate H and the most recent historical DL CSI estimate in Hₛ is lower than a first configured threshold, the WTRU may determine that the CSI feedback report does not include the actual CSI value. For example, the first configured threshold may correspond to the measured difference between the current DL estimate and the most recent historical DL CSI estimate at the WTRU. If the measured difference is lower than a first configured threshold, the CSI feedback report may (e.g., only) include a first (e.g., setup) portion that includes an indication to the gNB to use the most recent reconstructed DL CSI at the gNB in Ĥₛ to configure the DL transmission. For example, the WTRU may know Hₛ and/or it may feed it back to the gNB and/or the corresponding recovered CSI at the gNB may be Ĥₛ. For example, the resulting free payload from the CSI feedback report may be configured for physical uplink shared channel (PUSCH). For example, when the difference between the DL CSI estimate and a DL CSI estimate included in a sequence of historical DL CSI estimates at the WTRU is lower than a first threshold, the WTRU may generate the CSI feedback report such that the CSI feedback report includes a first (e.g., setup) portion that includes an indication to the network node to use the most recent reconstructed DL CSI at the network node based on a sequence of historical reconstructed DL CSI estimates at the network node to configure a DL transmission. For example, when the difference between the DL CSI estimate and a DL CSI estimate included in a sequence of historical DL CSI estimates at the WTRU is lower than a first threshold, the WTRU may generate the CSI feedback report such that the CSI feedback report includes a first (e.g., setup) portion that includes an indication to the network node to use a previously reconstructed DL CSI estimate included in a sequence of historical DL CSI estimates at the network node based on a sequence of historical reconstructed DL CSI estimates at the network node to configure a DL transmission.

If the measured distance between the current DL CSI estimate H and the most recent historical DL CSI estimate in Hₛ is higher than a first configured threshold, a WTRU may perform one or more of the following. The WTRU may compute the measured difference between H and the determined structure and parameters of filter F(Hₛ) (e.g., as described herein). The measured difference can be cosine similarity, mean squared error, and/or one or more (e.g., any) other metrics (e.g., the choice of the metric can be configured by the gNB). The WTRU may determine the content of the CSI feedback report based on the measured difference between H and the determined structure and parameters of filter F (e.g., as described herein). For example, the comparison may include a first comparison and a second comparison. The first comparison may include a first difference between the current DL CSI estimate H and a previous DL CSI estimate included in a sequence of historical DL CSI estimates at the WTRU (e.g., the most recent historical DL CSI estimate in Hₛ. The second comparison may include a second difference between the DL CSI estimate and an output of an adaptive filter applied to a sequence of historical DL CSI estimates at the WTRU. When the first difference is greater than a first threshold, the WTRU may generate the CSI report such that the content of the CSI feedback report is based on the second difference.

If the measured distance between the current DL CSI estimate H and the most recent historical DL CSI estimate in Hₛ is higher than a first configured threshold, and if the measured difference between the current DL CSI estimate and an output of an adaptive filter applied to the sequence of historical DL CSI estimates at the WTRU is lower than a second configured threshold, the CSI feedback report may include one or more of the following. If the measured difference between the current DL CSI estimate and an output of an adaptive filter applied to the sequence of historical DL CSI estimates at the WTRU is lower than a second configured threshold, the CSI feedback report may include an indication to the gNB to apply adaptive filtering to the sequence Ĥₛ of historical reconstructed DL CSI estimates at the gNB. For example, if the measured difference is lower than a second configured threshold, the CSI feedback report may include an index of the structure of the filter in the predefined book (e.g., if it was selected by the WTRU). If the measured difference is lower than a second configured threshold, the CSI feedback report may include one or more procedures (e.g., number of parameters and/or taps of the filter) on how to apply the determined filter F to the sequence of historical reconstructed DL CSI estimates Ĥₛ at the gNB. For example, the procedures may include the number of the filter. If the filter structed from the predefined book of filters has Q1 coefficients, for example, the WTRU may indicate to the gNB to use (e.g., only) the first Q2 (Q2<Q1) coefficients of the filter. If the measured difference between the current DL CSI estimate and an output of an adaptive filter applied to the sequence of historical DL CSI estimates at the WTRU is lower than a second configured threshold, the CSI feedback report may include a second (e.g., quantity) portion that includes one or more of the following. For example, when the second difference is lower than a second threshold, the WTRU may generate the CSI feedback report such that the CSI feedback report includes a first (e.g., setup) portion and a second (e.g., quantity) portion, where the first (e.g., setup) portion includes an indication to the network node to apply adaptive filtering to a sequence of historical reconstructed DL CSI estimates at the network node, an index of the structure of the filter in the predefined book (e.g., codebook), and/or one or more procedures on how to apply the determined filter to the sequence of historical reconstructed DL CSI estimates at the network node, and/or where the second (e.g., quantity) portion includes one or more parameters of the adaptive filter.

If the measured distance between the current DL CSI estimate H and the most recent historical DL CSI estimate in Hₛ is higher than a first configured threshold, and if the measured difference between the current DL CSI estimate and an output of an adaptive filter applied to the sequence of historical DL CSI estimates at the WTRU is lower than a second configured threshold, the CSI feedback report may include a second (e.g., quantity) portion that includes the parameters of the determined adaptive filter F. The WTRU may compress the parameters of the determined adaptive filter F into a quantized-binary representation with a preconfigured size (e.g., in bits), based on the structure of the determined filter F and/or the size of its parameters. The WTRU may be configured to use a compression model that compresses the parameters of the determined adaptive filter F into a binary representation with a configured size (e.g., in bits). The binary representation may be inserted in the quantity part. The gNB may use a reconstruction model to recover the compressed parameters of the determined adaptive filter F upon receiving the quantity part. The compression model and/or the reconstruction model(s) can be configured by the gNB. The compression model and the reconstruction model can be AI/ML-based models. For example, the compression model and/or the reconstruction model may include an auto-encoder based compression model, where the WTRU uses an AI/ML-based encoder to compress the parameters of the determined filter F and/or the gNB uses an AI/ML-based decoder to reconstruct the parameters of the determined filter F.

If the measured difference between the current DL CSI estimate H and the most recent historical DL CSI estimate in Hₛ is higher than a first configured threshold, and the measured difference is higher than a second configured threshold, a WTRU may determine the CSI feedback report to include one or more of the following. The WTRU may be configured to employ (e.g., either) AI/ML-based techniques for CSI feedback reporting and/or (e.g., legacy) non-AI/ML based techniques for CSI feedback reporting. For example, when the first difference (e.g., as described herein) is greater than a first threshold, and the second difference (e.g., as described herein) is greater than a second threshold, the WTRU may use AI/ML-based CSI feedback reporting technique(s) and/or non-AI/ML-based CSI feedback reporting techniques to generate the CSI feedback report. The AI/ML-based CSI feedback reporting techniques may include SF CSI compression and/or TSF CSI compression.

A WTRU may be configured to apply forward error correction (FEC) and/or modulation to the first (e.g., setup) portion and/or the second (e.g., quantity) portion of the CSI feedback report (e.g., either) separately and/or jointly with other uplink control information. The WTRU may be configured to use (e.g., either) the same and/or different FEC and/or modulation schemes to the setup part and/or the quantity part of the CSI feedback report.

A WTRU may send the CSI feedback report. The WTRU may transmit the CSI feedback report to the gNB. The WTRU may be configured to transmit the CSI feedback report on uplink control information (UCI), (e.g., either) on physical uplink control channel (PUCCH) and/or PUSCH), based on the content and/or the periodicity of the CSI feedback report, and/or triggering can be received by MAC CE and/or DCI. For example, triggering may be related to the transmission of the CSI feedback report. It may indicate to the WTRU on which uplink channel the WTRU may transmit the CSI feedback report to the gNB.

A gNB may receive the CSI feedback report. The gNB may apply demodulation and/or decoding to the CSI feedback report, for example, if the WTRU applied coding and/or modulation to the CSI feedback report. The gNB may read the setup part of the CSI feedback report. If the setup part of the CSI feedback report includes an indication to use the most recent reconstructed DL CSI at the gNB to configure the DL transmission, the gNB may use the most recent reconstructed DL CSI in Ĥₛ to configure the DL transmission. If the setup part of the CSI feedback report includes an indication to apply adaptive filtering to the sequence of historical reconstructed DL CSI estimates (e.g., as described herein), the gNB may perform one or more of the following. The gNB may read the index of the structure of the filter in the predefined book (e.g., if it was selected by the WTRU), along with the procedures on how to apply the determined adaptive filter F to the sequence of historical reconstructed DL CSI estimates Ĥₛ. The gNB may recover the parameters of the determined filter F. The gNB may reconstruct the parameters of the determined adaptive filter F if the parameters were compressed by the WTRU into a quantized-binary representation. The gNB may reconstruct the current DL CSI estimate as Ĥ=F(Ĥₛ). If the CSI feedback report includes an indication to use configured AI/ML based CSI feedback reporting and/or (e.g., legacy) non-AI/ML CSI feedback report, the gNB may recover the CSI 1 from the CSI feedback report.

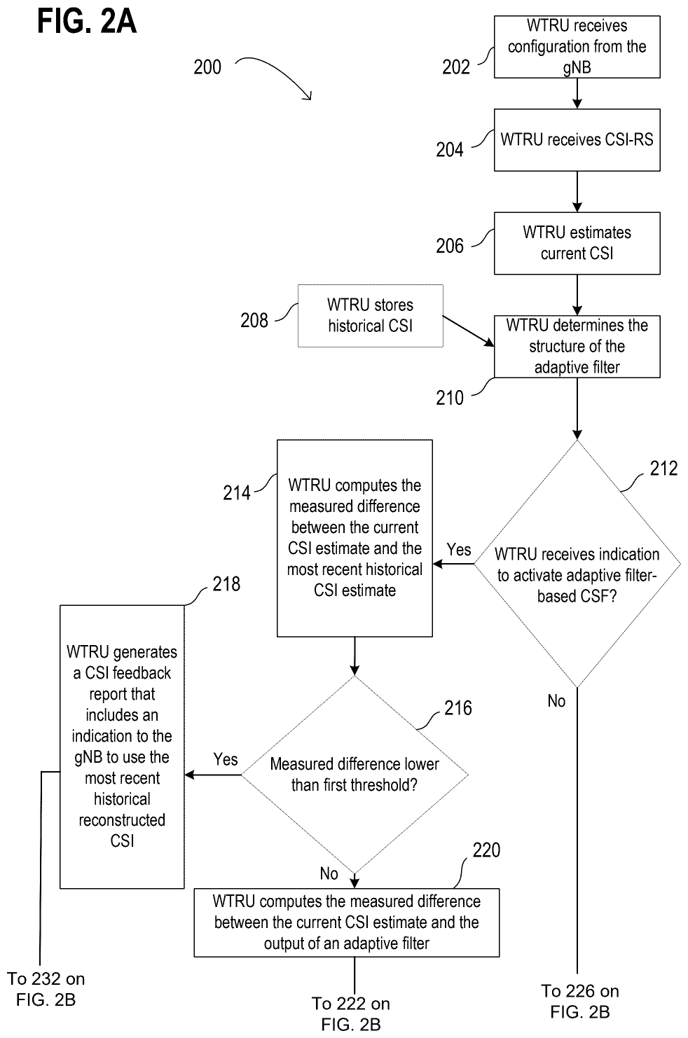

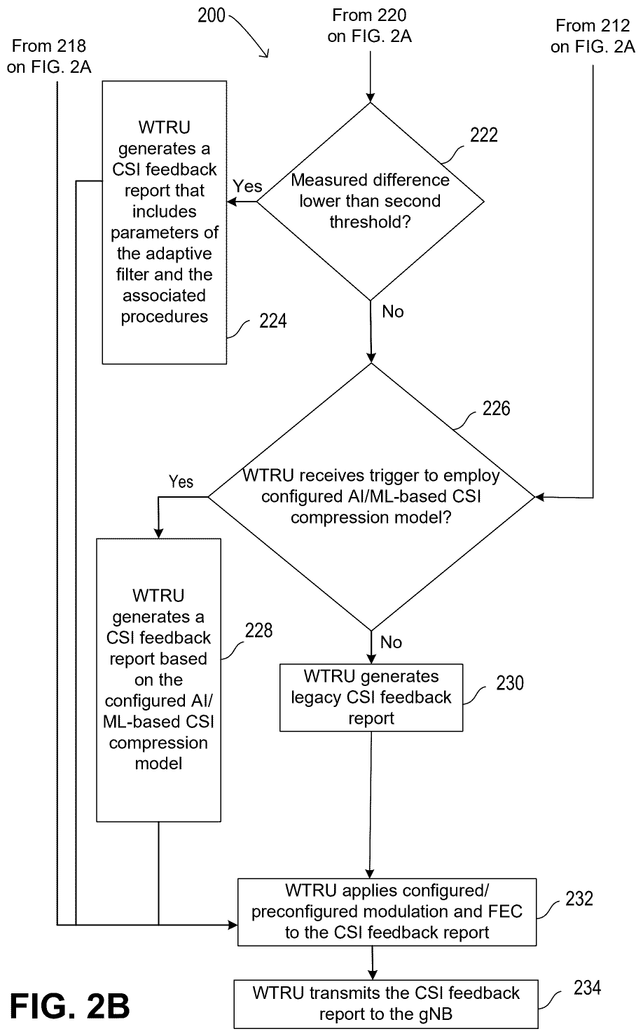

FIGS. 2A and 2B is a diagram of an example procedure for generating and/or transmitting a CSI feedback reporting 200.

At 202, the WTRU may receive configuration (e.g., as described herein). The WTRU configuration may include CSI-RS resource configuration(s) and/or CSI feedback reporting configuration.

At 204, the WTRU may receive a CSI-RS (e.g., as described herein). For example, the WTRU may receive one or more CSI-RSs in accordance with the CSI resource configuration information.

At 206, the WTRU may estimate current CSI. For example, the WTRU may determine a DL CSI estimate. The WTRU may determine the DL CSI estimate H based on one or more CSI-RSs received in accordance with the CSI resource configuration.

At 208, the WTRU may store the historical CSI. For example, the WTRU may store the historical DL CSI estimates (e.g., as described herein).

At 210, the WTRU may determine the structure of the adaptive filter. For example, the WTRU may determine the structure and parameters of an adaptive filter F that minimizes the measured difference between H and F(Hₛ).

At 212, the WTRU may receive an indication to activate adaptive filter-based CSF. For example, the WTRU may (e.g., dynamically) receive an indication to activate the adaptive filter via DCI and/or MAC CE. The gNB may determine to activate the adaptive filter-based CSF (e.g., based on performance feedback from the WTRU to the gNB that is associated to the historical DL CSI estimates (e.g., as described herein). The WTRU may receive a trigger to employ historical CSI estimates. The WTRU may receive the indication to activate the adaptive filter-based CSF via one or more RRC configurations.

At 214, the WTRU may compute the difference (e.g., measured difference) between the current (e.g., DL) CSI estimate and the most recent historical CSI estimate. For example, the WTRU may compute the measured difference between the current DL CSI estimate H and the most recent historical DL CSI estimate in Hₛ, which may be the most recent historical DL CSI to the current DL CSI, that was estimated at the WTRU, fed back from the WTRU to the gNB, and successfully reconstructed at the gNB. The measured difference can be cosine similarity, mean squared error (MSE), and/or one or more (e.g., any) other metric. The choice of the metric can be configured by the gNB.

At 216, the WTRU may determine whether the difference (e.g., first difference) between the current DL CSI estimate and the most recent historical DL CSI estimate (e.g., at the WTRU) is lower than a first threshold. The first threshold may be based on the metric used to quantify the (e.g., measured) difference. For example, if the measured difference is mean-squared-error (MSE), the first threshold can be equal to −5.5 (in the log 10 scale).

At 218, the WTRU may generate a CSI feedback report. The CSI feedback report may include an indication to the gNB to use the most recent historical reconstructed (e.g. DL) CSI (e.g., at the gNB) to configure the DL transmission.

At 220, the WTRU may compute the (e.g., measured) difference (e.g., as described herein) between the current (e.g., DL) CSI estimate and the output of an adaptive filter (e.g., applied to a sequence of historical DL CSI estimates at the WTRU).

At 222, the WTRU may determine whether the difference (e.g., second difference) between the current (e.g., DL) CSI estimate and output of the adaptive filter (e.g., applied to the sequence of historical DL CSI estimates at the WTRU) is lower than a second threshold. The second threshold may be based on the metric used to quantify the (e.g., measured) difference. For example, if the measured difference is mean-squared-error (MSE), the second threshold can be equal to −4.5 (in the log 10 scale).

At 224, the WTRU may generate a CSI feedback report (e.g., as described herein) that includes parameters of the adaptive filter and/or the associated procedures.

At 226, the WTRU may determine whether an indication and/or trigger (e.g., as described herein) was received to employ configured AI/ML-based CSI compression model(s).

At 228, the WTRU may generate a CSI feedback report based on the configured AI/ML-based compression model (e.g., SF and/or TSF CSI compression model).

At 230, the WTRU may generate (e.g., legacy) CSI feedback report. For example, the WTRU may generate the (e.g., legacy) CSI feedback report based on non-AI/ML compression model(s).

At 232, the WTRU may apply the (pre) configured modulation and/or FEC to the CSI feedback report (e.g., as described herein).

At 234, the WTRU may transmit the CSI feedback report. For example, the WTRU may send the CSI feedback report to the gNB.

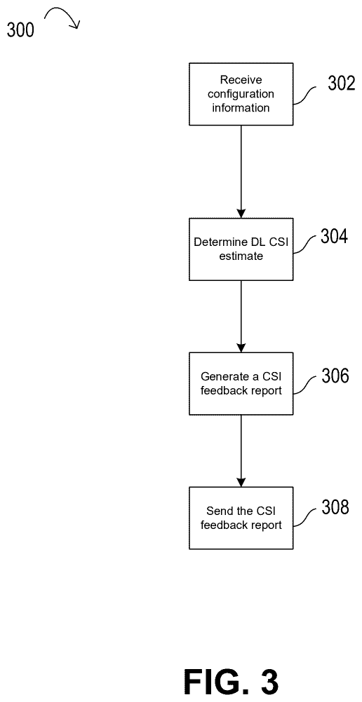

FIG. 3 is a diagram of an example procedure for generating and/or transmitting a CSI feedback reporting.

At 302, a WTRU may receive configuration information (e.g., as described herein, at 202). The configuration information may include CSI-RS resource configuration information and/or CSI feedback reporting configuration information.

At 304, the WTRU may determine a DL CSI estimate. The WTRU may determine the DL CSI estimate based on one or more CSI-RSs received in accordance with the CSI resource configuration information.

At 306, the WTRU may generate a CSI feedback report. The WTRU may generate the CSI feedback report based on a comparison between the DL CSI estimate and historical DL CSI estimates. For example, the comparison may include a first comparison and a second comparison, where the first comparison is based on a first difference between the DL CSI estimate and the most recent historical DL CSI estimate at the WTRU (e.g., at 214, at 216), and where the second comparison is based on a second difference between the DL CSI estimate and an output of an adaptive filter applied to a sequence of historical DL CSI estimates at the WTRU (e.g., at 220, at 222). Upon a determination that the first difference is greater than a first threshold (e.g., at 216), the content of the CSI feedback report is based on the second difference (e.g., at 220, at 222). The WTRU may generate the content of the CSI feedback report based on a difference between the DL CSI estimate and the most recent historical DL CSI estimate at the WTRU (e.g., at 214, at 218, at 224, at 228). Upon a determination that the first difference (e.g., at 216) is lower than a first threshold, the WTRU may generate a CSI feedback report that includes a first (e.g., setup) portion that includes an indication to the network node to use the most recent reconstructed DL CSI at the network node based on a sequence of historical reconstructed DL CSI estimates at the network node to configure a DL transmission. Upon a determination that the first difference (e.g., at 216) is greater than a first threshold, and the second difference (e.g., at 222) is lower than a second threshold, the CSI feedback report may include a first (e.g., setup) portion and a second (e.g., quantity) portion, where the first (e.g., setup) portion includes an indication to the network node to apply adaptive filtering to a sequence of historical reconstructed DL CSI estimates at the network node, an index of the structure of the filter in the predefined book (e.g., codebook), and/or one or more procedures on how to apply the determined filter to the sequence of historical reconstructed DL CSI estimates at the network node, and/or the second (e.g., quantity) portion includes parameters of the determined adaptive filter. Upon a determination that the first difference (e.g., at 216) is greater than a first threshold and the second difference (e.g., at 222) is greater than a second threshold, the WTRU may use artificial intelligence (AI)/machine learning (ML)-based (e.g., SF CSI compression, TSF CSI compression) CSI feedback reporting techniques (e.g., at 228) and/or non-AI/ML CSI feedback reporting techniques (e.g., at 230) to generate the CSI feedback report.

At 308, the WTRU may send the CSI feedback report. For example, the WTRU may transmit the CSI feedback report to the gNB (e.g., at 234).

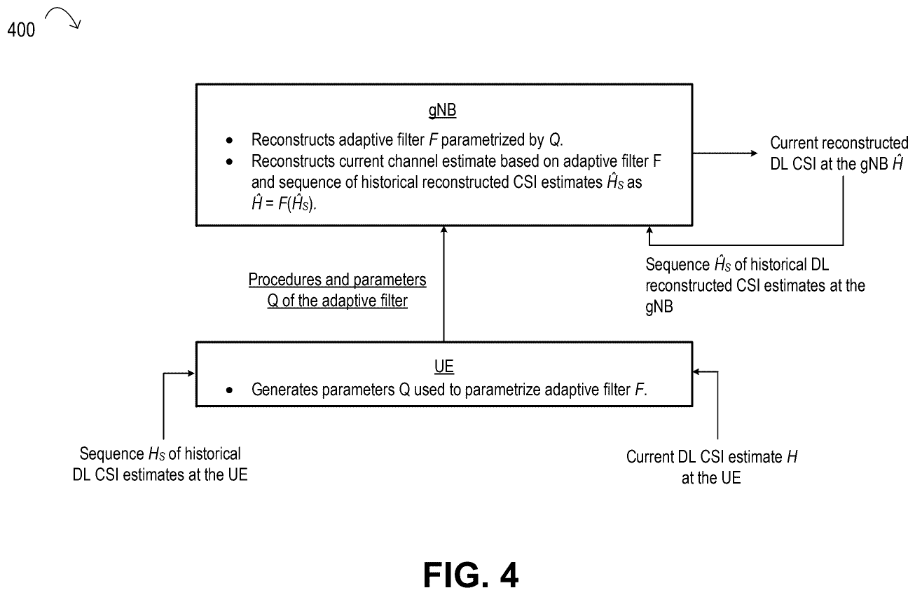

FIG. 4 depicts an example WTRU and/or gNB procedure(s) for adaptive filtering 400. The WTRU may generate parameters (e.g., Q) used to parametrize adaptive filter F. For example, the WTRU may generate parameters based on sequence Hₛ of historical DL CSI estimates at the WTRU and/or a current DL estimate H at the WTRU (e.g., based on the received CSI-RS). The gNB may reconstruct adaptive filter F parameterized by Q. The WTRU may send the gNB instructions (e.g., procedures and/or parameters) to the gNB for how to reconstruct a current DL CSI estimate from the historical DL CSI estimates. The gNB may reconstruct the adaptive filter F. The gNB may reconstruct the current channel estimate based on the adaptive filter F and/or the sequence of historical reconstructed CSI estimates Ĥₛ as Ĥ=F(Ĥₛ). The gNB may determine the current reconstructed DL CSI at the gNB Ĥ. The gNB may store the Ĥ. For example, the gNB may store Ĥ in the sequence Ĥₛ of historical DL reconstructed CSI estimates at the gNB.

Embodiments described herein may relate to methods for hybrid AI/ML for CSI feedback enhancements. Since historical information may be retained at the receiver of CSI feedback (e.g., AI/ML model outputs), rather than sending one or more (e.g., multiple) downlink (DL) CSI estimates (and/or compressed/predicted versions thereof), the WTRU may send instructions to the gNB for how to reconstruct a current DL CSI estimate from the historical DL CSI estimates. In examples, these instructions can be a set of parameters of a pre-agreed function and/or filter. An adaptative filter may be combined with a static and/or a semi-static AI/ML model for CSI compression and/or prediction. Embodiments described herein the filter being an AI/ML model and/or the signaled parameters may be the parameters of the model. Embodiments described herein may include methods, and/or procedures for determining such adaptive filter at the WTRU and/or for generating the associated CSI feedback report that includes the adaptive filter along with the instructions on how to reconstruct the CSI at the gNB from the historical reconstructed DL CSI estimates at the gNB. Embodiments described herein may be applicable to temporal/spatial/frequency (TSF) CSI compression and/or to joint CSI compression and prediction. CSI estimates can be (e.g., either) the estimated DL raw channel matrices and/or the eigenvectors associated to the estimated raw channel matrices. Embodiments described herein may be applicable to both types of CSI. For example, embodiments described herein may be applicable to one or more (e.g., any) type of transmitting and/or receiving node(s), including wireless transmit/receive unit (WTRU) and/or network node(s), WTRUs using sidelink, and/or WTRU-to-WTRU direct communication.

The current DL CSI estimate at the WTRU may be referred to as the instantaneous estimated DL CSI at the WTRU upon the reception of CSI-RS. The current DL CSI estimate at the WTRU may be denoted by H.

The sequence of historical DL CSI estimates at the WTRU may be referred to as a sequence that includes the historical DL CSI estimates at the WTRU prior to the current DL CSI estimate H, that have been reported back to the gNB. The sequence of historical DL CSI estimates at the WTRU may be denoted by Hₛ.

The current reconstructed DL CSI estimate at the gNB may be referred to as the reconstructed DL CSI estimate at the gNB from the CSI feedback report transmitted by the WTRU that is associated to the current DL CSI estimate H at the WTRU. The current reconstructed DL CSI estimate at the gNB is denoted by Ĥ.

The sequence of historical reconstructed DL CSI estimates at the gNB may be referred as a sequence that includes the historical reconstructed DL CSI estimates at the gNB, prior to the current reconstructed DL CSI estimate Ĥ, from the prior CSI feedback reports transmitted by the WTRU that are associated to the historical DL CSI estimates at the WTRU in the sequence Hₛ. The sequence of historical reconstructed DL CSI estimates at the gNB may be denoted by Ĥₛ.

A WTRU may be configured to employ an AI/ML model for CSI feedback reporting (e.g., channel state feedback (CSF) reporting). The procedures of the AI/ML process may be detailed herein. A WTRU may be configured to receive and/or process input data. Input data may include DL CSI estimate H (e.g., full raw channel and/or eigenvectors of the raw channel).

A WTRU may be configured to preprocess (e.g., input) the received CSI-RS. Preprocessing may include extracting the CSI-RS from the received signals, for example, by using the CSI-RS resource allocations. Preprocessing may include division by (and/or multiplication by conjugate of) the known CSI-RS symbols. Preprocessing may include applying an interpolation and/or a 2D filtering to the CSI-RS carrying resource elements (Res). Preprocessing may include applying singular value decomposition (SVD) to estimated full DL raw channel, for example, if the CSI feedback reporting is based on the eigenvectors of the estimated full DL raw channel. Preprocessing may include resizing the input data shape. Preprocessing may include concatenation of the real and/or imaginary parts to obtain the real-valued input to the AI/ML model.

For the CSI feedback, one or more (e.g., various) AI/ML models may include CSI compression including CsiNet, EVCsiNet, etc. Based on the autoencoder architecture, for example, the AI/ML models for compression may employ an encoder at the WTRU to compress the DL CSI estimate H (e.g., full raw channel and/or eigenvectors of the raw channel) into a low dimensional quantized-binary representation that is transmitted to the gNB in the CSI feedback report, and/or a decoder at the gNB to reconstruct the DL CSI estimate Ĥ from the CSI feedback report.

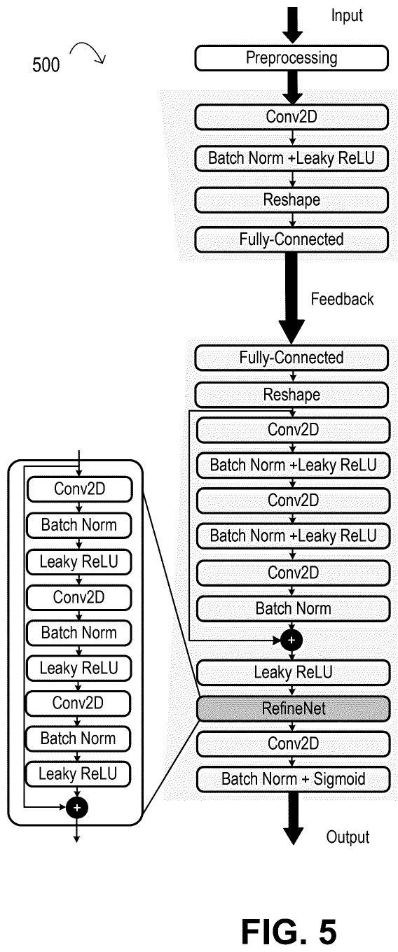

FIG. 5 depicts an example CsiNet model architecture 500. FIG. 5 depicts the CsiNet model architecture, which may include convolutional layers, batch normalization layers, leaky ReLU and/or Sigmoid activation layers, and/or residual connections. The joint and/or cascaded operation(s) of these layers may provide the compression operation. These different layers together may compress the DL CSI estimate. For example, the different layers may be needed to compress the DL CSI estimate. When AI/ML-based techniques are used for CSI compression, for example, the WTRU may generate, using its encoder, a binary CSI feedback report. The CSI feedback report may be sent to the gNB. The gNB may feed the received CSI feedback report to its decoder to reconstruct the DL CSI. RefineNet may be a part and/or a block of layers within the CsiNet model and/or may not be a part of the training of the model. The (e.g., entire) CsiNet model (Encoder+Decoder) may be trained (e.g., as described herein).

A WTRU may be configured to generate and/or process output data. Output data may include reconstructed DL CSI estimate A.

A WTRU may be configured to train one or more models. For example, the WTRU may be configured to train one or more AI/ML models. Training may be performed online and/or offline (e.g., in a supervised manner). The features can be (e.g., either) the error-free ground-truth (e.g., target) DL CSI and/or the real DL CSI estimate. The features can be (e.g., either) the full DL raw channel (e.g., for CsiNet) and/or the eigenvectors of the DL full raw channel (e.g., for EVCsiNet). Training may include a loss function. The loss function can be the mean squared error (MSE) and/or the cosine similarity between the error-free ground-truth (e.g., target) DL CSI and/or the real DL CSI estimate (e.g., input to the encoder) and the reconstructed error-free ground-truth (e.g., target) DL CSI and/or the real DL CSI estimate (e.g., output of the decoder).

For TSF CSI compression, the same AI/ML model architectures can be used, by adapting the input layer at the encoder to include the sequence of historical DL CSI estimates, and/or to include the historical reconstructed DL CSI estimates at the decoder.

When a WTRU is configured to perform adaptive filtering for CSI feedback reporting, one or more (e.g., key) parameters may be configured by the NW. The WTRU may be configured with one or more of the following parameters to perform adaptive filtering for CSI feedback reporting. The WTRU may be configured with CSI-RS resource configurations. The CSI-RS resource configurations may include CSI-RS periodicity, location, density, etc. The WTRU may be configured with CSI feedback reporting configuration. CSI feedback reporting configuration may include reporting type (e.g., periodic, semi-persistent, and/or aperiodic), report quantity (e.g., configuration of AI/ML based CSI feedback report), and/or configuration of CSF parameters.

When a WTRU is configured to perform adaptive filtering for CSI feedback reporting, the WTRU may be configured with activation of adaptive filter-based CSF. The WTRU may receive the activation dynamically (e.g., via DCI and/or MAC CE). The gNB may determine to activate adaptive filter-based CSF. For example, the gNB may determine to activate filter-based CSF based on the performance feedback from the WTRU to the gNB that is associated with the historical DL CSI estimates. Performance feedback may include block error rate (BLER), one or more (e.g., a number of) acknowledgements (ACKs), and/or one or more (e.g., a number of) negative ACKs (NACKs). The activation may include a size of the time window (e.g., number of DL time slots), a length of the sequence of historical DL CSI estimates at the WTRU, and/or one or more thresholds to trigger CSF filter parameter update. For example, the activation may include one or more thresholds to trigger and/or employ the adaptive filter. The term CSF filter parameter update and (e.g., determined) adaptive filter may be used interchangeably herein.

When a WTRU is configured to perform adaptive filtering for CSI feedback reporting, the WTRU may be configured with MCS for the CSI feedback report. When a WTRU is configured to perform adaptive filtering for CSI feedback reporting, the WTRU may be configured with uplink (UL) radio configuration for the CSI feedback report transmission (Res, transmit power, etc.).

One or more (e.g., two) signaling may be described herein for the adaptive filtering technique for CSI feedback reporting. Signaling may include the activation of adaptive filter-based CSF transmitted by the NW to the WTRU. The activation may indicate a size of the time window (e.g., number of DL time slots), a length of the sequence of historical DL CSI estimates at the WTRU, one or more thresholds to trigger CSF filter parameter update, etc., and/or MCS and/or UL radio configuration for the CSI feedback report transmission (e.g., Res, transmit power, etc.). The WTRU may receive the activation dynamically (e.g., via DCI and/or MAC CE). The message of the CSI feedback report may be transmitted by the WTRU as the response to the activation of adaptive filter-based CSF transmitted by the NW. The CSI feedback report message may include a first (e.g., setup) portion and/or a second (e.g., quantity) portion. The first (e.g., setup) portion may include an indication to the gNB to apply adaptive filtering to the sequence of historical reconstructed DL CSI estimates at the gNB. The first (e.g., setup) portion may include the index of the structure of the filter in the predefined book (e.g., codebook), for example, if it was selected by the WTRU. The first (e.g., setup) portion may include one or more procedures on how to apply the determined filter F to the sequence of historical reconstructed DL CSI estimates Ĥₛ at the gNB. Examples of procedures may include one or more (e.g., a number of) parameters and/or taps of the filter. The second (e.g., quantity) portion may include one or more parameters of the determined adaptive filter F. The CSI feedback report message can be transmitted on uplink control information (UCI) (e.g., either) on PUCCH and/or PUSCH, based on the content and/or the periodicity of the CSI feedback report, for example.

A WTRU may be configured to perform adaptive filtering for CSI feedback reporting. Procedures for determining such adaptive filtering and/or for generating the associated CSI feedback report that includes the adaptive filter along with the instructions on how to reconstruct the CSI at the gNB from the historical reconstructed DL CSI estimates at the gNB may be described herein.

A WTRU may receive configuration information. The WTRU may receive configuration information from the gNB for one or more of the following. The WTRU may receive configuration information that includes CSI-RS configuration, CSI feedback reporting configuration, and/or one or more thresholds configurations. The one or more thresholds may be different, and/or may be configured dynamically by the NW. The WTRU may be configured dynamically with the first and/or second thresholds (e.g., as described herein). For each CSI feedback reporting triggering, the WTRU may receive the threshold(s) configuration, along with other configuration information, from the NW through DCI and/or MAC CE. The configuration information may include CSI-RS resource configuration information and/or CSI feedback reporting configuration information. For example, the WTRU may receive CSI-RS resource configurations, which may include the CSI-RS periodicity, location, density, etc. The WTRU may receive CSI feedback reporting configuration. For example, CSI feedback reporting configuration may include (e.g., CSI-RS) reporting/configuration type (e.g., periodic, semi-persistent, and/or aperiodic), report quantity (e.g., configuration of AI/ML based CSI feedback report), and/or configuration of channel state feedback (CSF) parameters. CSF parameters may include value of time window and/or one or more (e.g., a number of) CSI estimates used for CSF, threshold(s) to trigger CSF filter parameter update, etc.

A WTRU may receive CSI-RS according to the configuration (e.g., as described herein).

A WTRU may estimate the current DL CSI (e.g., H), based on the received CSI-RS. For example, the WTRU may determine a DL CSI estimate based on one or more CSI-RSs received in accordance with the CSI resource configuration information.

A WTRU may apply AI/ML-based techniques for CSI feedback reporting. For example, the WTRU may apply (e.g., as described herein) Spatial/Frequency (SF) CSI Compression and/or Temporal/Spatial/Frequency (TSF) CSI compression.

One or more (e.g., two) methods for the WTRU to start applying CSF configuration may be described herein. A first method may include no additional activation (e.g., needed) after radio resource control (RRC) configurations. A second method may include a WTRU that receives an activation of adaptive filter-based CSF. For example, the WTRU may receive the activation of adaptive filter-based CSF dynamically (e.g., via downlink control information (DCI) and/or medium access control (MAC) control element (CE) (MAC CE). The WTRU may receive, via DCI and/or MAC CE, an indication to activate filtering associated with the difference. The indication to activate may include activation information. The activation information may include one or more of a size of a time window, a length of a sequence of historical DL CSI estimates at the WTRU, and/or one or more thresholds to trigger an adaptive filter parameter update. The WTRU may generate the CSI feedback report based on the activation information. For example, the processor of a WTRU may be configured to generate the CSI feedback report based on the activation information. The gNB may determine to activate the adaptive filter-based CSF based on the performance feedback from the WTRU to the gNG (e.g., block error rate (BLER), number of acknowledgements (ACK) and/or negative ACK (NACK)) that are associated to the historical DL CSI estimates. The activation may include the size of the time window (e.g., number of DL time slots), the length of the sequence Hₛ of historical DL CSI estimates at the WTRU, and/or one or more thresholds to trigger CSF filter parameter update, etc. The threshold(s) may be based on the metric used to quantify the measured difference. For example, as described herein, if the measured difference is mean-squared error (MSE), the first threshold can be equal to −5.5 (in the log 10 scale) and the second threshold can be equal to −4.5 (in the log 10 scale).

A WTRU may store the historical DL CSI estimates. For example, the WTRU may store the historical DL CSI estimates, that have been reported back to the gNB over a time window, into a sequence of historical DL CSI estimates Hₛ, and/or may use the historical DL CSI estimates for CSI feedback reporting (e.g., upon receiving the activation).

The gNB may store the historical reconstructed DL CSI estimates that have been reconstructed based on the prior CSI feedback reports that are associated to the sequence Hₛ of historical DL CSI estimates at the WTRU, into a sequence of historical reconstructed DL CSI estimates Ĥₛ.

A WTRU may generate a CSI feedback report to the gNB. The WTRU may generate the CSI feedback report based on activation information (e.g., as described herein). The WTRU may generate the CSI feedback report based on a comparison between a DL CSI estimate and historical DL CSI estimates. For example, the WTRU may generate the CSI feedback report based on a difference between a DL CSI estimate and a DL CSI estimate included in a sequence of historical DL CSI estimate (e.g., at the WTRU). For example, the WTRU may generate the CSI feedback report based on a difference between the DL CSI estimate(s) and filtered DL CSI estimated (e.g., the output of a filter applied to the historical DL CSI estimates). For example, the WTRU may generate the CSI feedback report based on the CSI-RS configuration type (e.g., periodic, semi-persistent, and/or aperiodic). The CSI feedback report may include one or more of the following. The CSI feedback report may include an explicit and/or a modified (e.g., compressed) representation of the combination between the current DL CSI estimate H and the sequence of historical DL CSI estimates Hₛ. The CSI feedback report may include instructions on how to reconstruct the current DL CSI estimate at the gNB (e.g., a network node) based on the sequence Ĥₛ of historical (e.g., reconstructed) DL CSI estimates at the gNB (e.g., an adaptive filter and its parameters). For example, the CSI feedback report may include instructions on how to reconstruct the DL CSI estimate at a network node based on historical DL CSI estimates at the network node. The contents of the CSI feedback report may be based on a difference between the DL CSI estimate and the most recent historical DL CSI estimate at the WTRU. For example, the WTRU may generate the content of the CSI feedback report based on a difference between the DL CSI estimate and a DL CSI estimate included in a sequence of historical DL CSI estimates at the WTRU.

The DL CSI estimates may be synchronized between a WTRU and the network. The DL CSI estimates at the WTRU may not be the same as the DL CSI estimates at the network node. For example, the WTRU may have the (e.g., exact) DL CSI estimated which are fed back to the gNB. The gNB may reconstruct the DL CSI estimates, for example, based on the feedback from the WTRU. The historical reconstructed estimates at the gNB may be equal to the historical DL CSI estimates at the WTRU plus some reconstruction error.

A WTRU may determine the structure and/or the parameters of an adaptive filter F that minimizes the measured difference between H and F(Hₛ). For example, the WTRU may determine a structure and/or one or more parameters of an adaptive filter to minimize a (e.g., measured) difference between the DL estimate and a sequence of historical DL CSI estimates at the WTRU associated with the adaptive filter. Example of parameters of the filter may include the coefficients of the filter. For example, if the filter is a finite impulse response (FIR) filter, the parameters of the filter may include the coefficients of the taps of the filter.

The structure of the filter F can be specified. For example, the structure of F can be specified in the standards and/or a book of predefined filters that are configured by RRC signaling. The gNB and/or the WTRU can select the filter to use from the configured book/list of filters. When the structure of the filter F is selected by the gNB, one or more of the following may occur. The gNB may select the structure of the filter F from a predefined book known to the WTRU. The WTRU may receive the index of the structure of the filter F in the predefined book (e.g., codebook). The WTRU may receive the index of the structure of the filter in the book in a DCI. The WTRU may determine the (e.g., optimal) parameters of the selected structure of the filter F. When the structure of the filter F is selected by the WTRU, one or more of the following may occur. The WTRU may browse the (e.g., entire) predefined book of structures of filters and/or may select a structure and/or parameters that minimizes the measured difference between H and F(Hₛ). The measured difference can be cosine similarity, mean squared error, and/or one or more (e.g., any) other metrics (e.g., the choice of the metric can be configured by the gNB).

A WTRU may compute the (e.g., measured) difference between the current DL CSI estimate H and the most recent historical DL CSI estimate in Hₛ, which may be the most recent historical DL CSI to the current DL CSI, that was estimated at the WTRU, fed back from the WTRU to the gNB, and/or (e.g., successfully) reconstructed at the gNB. For example, the WTRU may measure the difference between the DL CSI estimate and the most recent historical CSI estimate at the WTRU. For example, the WTRU may measure a difference between the DL CSI estimate and a DL CSI estimate included in a sequence of historical DL CSI estimates at the WTRU. The measured difference can be cosine similarity, mean squared error, and/or one or more (e.g., any) other metrics (e.g., the choice of the metric can be configured by the gNB).

If the measured difference between the current DL CSI estimate H and the most recent historical DL CSI estimate in Hₛ is lower than a first configured threshold, the WTRU may determine that the CSI feedback report does not include the actual CSI value. For example, the first configured threshold may be associated with the measured difference between the current DL estimate and the most recent historical DL CSI estimate at the WTRU. If the measured difference is lower than a first configured threshold, the CSI feedback report may (e.g., only) include a first (e.g., setup) portion that includes an indication to the gNB to use the most recent reconstructed DL CSI at the gNB in Ĥₛ to configure the DL transmission. For example, the WTRU may know Hₛ and/or it may feed it back to the gNB and/or the corresponding recovered CSI at the gNB may be Ĥₛ. For example, the resulting free payload from the CSI feedback report may be configured for physical uplink shared channel (PUSCH). For example, when the difference between the DL CSI estimate and a DL estimate included in a sequence of historical DL CSI estimates at the WTRU is lower than a first threshold, the WTRU may generate the CSI feedback report such that the CSI feedback report includes a first (e.g., setup) portion that includes an indication to the network node to use the most recent reconstructed DL CSI at the network node based on a sequence of historical reconstructed DL CSI estimates at the network node to configure a DL transmission. For example, when the difference between the DL CSI estimate and a DL CSI estimate included in a sequence of historical DL CSI estimates at the WTRU is lower than a first threshold, the WTRU may generate the CSI feedback report such that the CSI feedback report includes a first (e.g., setup) portion that includes an indication to the network node to use a previously reconstructed DL CSI estimate included in a sequence of historical DL CSI estimates at the network node based on a sequence of historical reconstructed DL CSI estimates at the network node to configure a DL transmission.

If the measured distance between the current DL CSI estimate H and the most recent historical DL CSI estimate in Hₛ is higher than a first configured threshold, a WTRU may perform one or more of the following. The WTRU may compute the measured difference between H and the determined structure and parameters of filter F(Hₛ) (e.g., as described herein). The measured difference can be cosine similarity, mean squared error, and/or one or more (e.g., any) other metrics (e.g., the choice of the metric can be configured by the gNB). The WTRU may determine the content of the CSI feedback report based on the measured difference between H and the determined structure and parameters of filter F (e.g., as described herein). For example, the comparison may include a first comparison and a second comparison. The first comparison may include a first difference between the current DL CSI estimate H and a previous DL CSI estimate included in a sequence of historical DL CSI estimates at the WTRU (e.g., the most recent historical DL CSI estimate in Hₛ). When the first difference is greater than a first threshold, the WTRU may generate the CSI report such that the content of the CSI feedback report is based on the second difference.

If the measured distance between the current DL CSI estimate H and the most recent historical DL CSI estimate in Hₛ is higher than a first configured threshold, and if the measured difference between the current DL CSI estimate and an output of an adaptive filter applied to the sequence of historical DL CSI estimates at the WTRU is lower than a second configured threshold, the CSI feedback report may include one or more of the following. If the measured difference between the current DL CSI estimate and an output of an adaptive filter applied to the sequence of historical DL CSI estimates at the WTRU is lower than a second configured threshold, the CSI feedback report may include an indication to the gNB to apply adaptive filtering to the sequence Ĥₛ of historical reconstructed DL CSI estimates at the gNB. For example, if the measured difference is lower than a second configured threshold, the CSI feedback report may include an index of the structure of the filter in the predefined book (e.g., if it was selected by the WTRU). If the measured difference is lower than a second configured threshold, the CSI feedback report may include one or more procedures (e.g., number of parameters and/or taps of the filter) on how to apply the determined filter F to the sequence of historical reconstructed DL CSI estimates Ĥₛ at the gNB. The procedures may include the number of parameters of the filter. For example, if the filter structured from the predefined book of filters has Q1 coefficients, the WTRU may indicate to the gNB to use (e.g., only) the first Q2 (Q2<Q1) coefficients of the filter. If the measured difference between the current DL CSI estimate and an output of an adaptive filter applied to the sequence of historical DL CSI estimates at the WTRU is lower than a second configured threshold, the CSI feedback report may include a second (e.g., quantity) portion that includes one or more of the following. For example, when the second difference is lower than a second threshold, the WTRU may generate the CSI feedback report such that the CSI feedback report includes a first (e.g., setup) portion and a second (e.g., quantity) portion, where the first (e.g., setup) portion includes an indication to the network node to apply adaptive filtering to a sequence of historical reconstructed DL CSI estimates at the network node, an index of the structure of the filter in the predefined book (e.g., codebook), and/or one or more procedures on how to apply the determined filter to the sequence of historical reconstructed DL CSI estimates at the network node, and/or where the second (e.g., quantity) portion includes one or more parameters of the adaptive filter.

If the measured distance between the current DL CSI estimate H and the most recent historical DL CSI estimate in Hₛ is higher than a first configured threshold, and if the measured difference between the current DL CSI estimate and an output of an adaptive filter applied to the sequence of historical DL CSI estimates at the WTRU is lower than a second configured threshold, the CSI feedback report may include a second (e.g., quantity) portion that includes the parameters of the determined adaptive filter F. The WTRU may compress the parameters of the determined filter F into a quantized-binary representation with a preconfigured size (e.g., in bits), based on the structure of the determined adaptive filter F and/or the size of its parameters. The WTRU may be configured to use a compression model that compresses the parameters of the determined F into a binary representation with a configured size (e.g., in bits). The binary representation may be inserted in the quantity part. The gNB may use a reconstruction model to recover the compressed parameters of the determined adaptive filter F upon receiving the quantity part. The compression model and/or the reconstruction model(s) can be configured by the gNB. The compression model and the reconstruction model can be AI/ML-based models. For example, the compression model and/or the reconstruction model may include an auto-encoder based compression model, where the WTRU uses an AI/ML-based encoder to compress the parameters of the determined filter F and/or the gNB uses an AI/ML-based decoder to reconstruct the parameters of the determined filter F.

If the measured difference between the current DL CSI estimate H and the most recent historical DL CSI estimate in Hₛ is higher than a first configured threshold, and the measured difference is higher than a second configured threshold, a WTRU may determine the CSI feedback report to include one or more of the following. The WTRU may be configured to employ (e.g., either) AI/ML-based techniques for CSI feedback reporting and/or (e.g., legacy) non-AI/ML based techniques for CSI feedback reporting. For example, when the first difference (e.g., as described herein) is greater than a first threshold, and the second difference (e.g., as described herein) is greater than a second threshold, the WTRU may use AI/ML-based CSI feedback reporting technique(s) and/or non-AI/ML-based CSI feedback reporting techniques to generate the CSI feedback report. The AI/ML-based CSI feedback reporting techniques may include SF CSI compression and/or TSF CSI compression.

A WTRU may be configured to apply forward error correction (FEC) and/or modulation to the first (e.g., setup) portion and/or the second (e.g., quantity) portion of the CSI feedback report (e.g., either) separately and/or jointly with other uplink control information. The WTRU may be configured to use (e.g., either) the same and/or different FEC and/or modulation schemes to the setup part and/or the quantity part of the CSI feedback report.

A WTRU may send the CSI feedback report. The WTRU may transmit the CSI feedback report to the gNB. The WTRU may be configured to transmit the CSI feedback report on uplink control information (UCI), (e.g., either) on physical uplink control channel (PUCCH) and/or PUSCH), based on the content and/or the periodicity of the CSI feedback report, and/or triggering can be received by MAC CE and/or DCI. For example, triggering may be related to the transmission of the CSI feedback report. It may indicate to the WTRU on which uplink channel the WTRU may transmit the CSI feedback report to the gNB.

A gNB may receive the CSI feedback report. The gNB may apply demodulation and/or decoding to the CSI feedback report, for example, if the WTRU applied coding and/or modulation to the CSI feedback report. The gNB may read the setup part of the CSI feedback report. If the setup part of the CSI feedback report includes an indication to use the most recent reconstructed DL CSI at the gNB to configure the DL transmission, the gNB may use the most recent reconstructed DL CSI in Ĥₛ to configure the DL transmission. If the setup part of the CSI feedback report includes an indication to apply adaptive filtering to the sequence of historical reconstructed DL CSI estimates (e.g., as described herein), the gNB may perform one or more of the following. The gNB may read the index of the structure of the filter in the predefined book (e.g., if it was selected by the WTRU), alone with the procedures on how to apply the determined adaptive filter F to the sequence of historical reconstructed DL CSI estimates Ĥₛ. The gNB may recover the parameters of the determined filter F. The gNB may reconstruct the parameters of the determined filter F if the parameters were compressed by the WTRU into a quantized-binary representation. The gNB may reconstruct the current DL CSI estimate as Ĥ=F(Ĥₛ). If the CSI feedback report includes an indication to use configured AI/ML based CSI feedback reporting and/or (e.g., legacy) non-AI/ML CSI feedback report, the gNB may recover the CSI Ĥ from the CSI feedback report.

Numerical results may be described herein for the performance evaluation of the adaptive filtering technique(s) for CSI feedback reporting. The simulations may be performed via Sionna, which is an open-source Python library for the link-level simulations that is based on TensorFlow, Table 1 outlines the simulation parameters.

TABLE 1
Simulation Parameters

| Number of Antenna at gNB | 16 |
|---|---|
| Number of Antenna at UE | 2 |
| Number of Layers L | 2 |
| Channel Model | CDL-B |

| | | |
|---|---|---|
| Carrier frequency | 2 | GHz |
| Delay Spread | 300 | ns |
| UE Velocity | 10 | km/h |
| Subcarrier Spacing | 15 | kHz |

| | |
|---|---|
| Number of RBs | 52 |
| Number of RBs per subband | 2 |

| | | |
|---|---|---|
| Bandwidth | 10 | MHz |

| | |
|---|---|
| CSI Type | Full raw channel |
| Length of historical CSI sequence | 4 CSI Estimates |

| | | |
|---|---|---|
| CSI-RS periodicity | 5 | ms |

| | |
|---|---|
| Number of latent variables | (payload size)/2 |
| Quantization | Scalar quantization with 2 |
| | bits per latent variable |

The AI/ML models may be trained with CSI data generated on the fly for 200 runs, where each run may include 500 consecutive time slots, and/or a batch of 300 raw channel matrices per time slot. The structure of the adaptive filter may be linear, quadratic, one or more (e.g., any) parameter function, AI/ML model, and/or the like. The adaptive filter used for CSI feedback reporting may be a four-tap time-variant finite impulse response (FIR) filter that has four complex-valued scalar coefficients to be determined. After determining the optimal four complex-valued scalar coefficients, for example, the WTRU may end up with 8 real-valued scalar coefficients (e.g., two real-valued scalar coefficients associated to the real and imaginary parts of each complex-valued scalar coefficient). The WTRU may quantize each coefficient of the 8 real-valued scalar coefficients into a 16-bit quantized-binary representation. The WTRU may require 8×16=128 bits to quantify the parameter(s) of the time-variant adaptive filter in the CSI feedback report.

The measured difference used in the CSI feedback reporting mechanism may be the mean-squared error (MSE). The first and/or second threshold(s) may be configured based on the test scenario and/or may be provided in the results in Table 2 and/or Table 3 (e.g., as described herein). To evaluate the performance of the CSI feedback reporting scheme, performance may be compared to a (e.g., conventional) AI/ML-based CSI feedback reporting mechanism (e.g., baseline), that is Temporal/Spatial/Frequency (TSF) CSI compression (e.g., as described herein). Additionally or alternatively, to assess the performance gain achieved by the CSI feedback reporting scheme compared to the baseline, one or more (e.g., two) intermediate key performance indicators (KPIs) (e.g., square generalized cosine similarity (SGCS) and the CSI feedback overhead) may be employed. The SGCS may measure the similarity between the eigenvectors of the error-free ground truth CSI and the reconstructed CSI at the gNB in each resource unit (subband, RB, etc.). The number of resource units may be referred as N. The eigenvectors may be associated with the configured DL transmission layers by the gNB. The number of layers may be referred to as L. For each i between 1 and N and for each j between 1 and L, the SGCS of the jth layer at the ith resource unit may be given by:

$$SGCS = \frac{{‖ {\hat{w}}_{i}^{{j}^{H}} {w}_{i}^{j} ‖}^{2}}{‖ {\hat{w}}_{i}^{{j}^{H}} ‖ ‖ {w}_{i}^{j} ‖}$$

where

$${w}_{i}^{j} and {\hat{w}}_{i}^{{j}^{H}}$$

are the j^{th} eigenvectors of the target CSI and the reconstructed CSI at ith resource unit, respectively. H may refer to the mathematical operation(s) for matrices and/or it may represent the transpose conjugate operation of a matrix (e.g., including vectors).

Table 2 depicts an example performance/overhead comparison between the proposed and conventional CSI feedback reporting mechanisms for payload size of 128 bits. Table 2 presents the SGCS performance of the first and second layers along with the resulting overhead for the CSI feedback reporting scheme and the (e.g., conventional) AI/ML-based TSF CSI compression scheme for payload size of 128 bits. When the first and second configured thresholds are both equal to −4.5 (in the log 10 scale), the CSI feedback reporting scheme may provide 10% and 17.14% SGCS gain for the first and second layers, respectively, with the same CSI feedback overhead of 128 bits compared to (e.g., conventional) AI/ML-based TSF CSI compression scheme. For example, the ideal SGCS may be 1. For example, SGCS gain of the first layer may be calculated as (0.88−0.80)/0.80*100=10%. For example, SGCE gain of the second layer may be calculated as (0.82−0.70)/0.70*100=17.14%. When the first and second configured thresholds are equal to −3.5 and −3 (in the log 10 scale), respectively, the CSI feedback reporting scheme may achieve the same SGCS performance for both layers, but with 50% overhead reduction compared to conventional AI/ML-based TSF CSI compression scheme. For example, SGCS in layer 1 may remain 0.80, and SGCE in layer 2 may remain 0.70, but the overhead (bits) may be reduced from 128 to 64.

TABLE 2
Performance/Overhead Comparison between proposed and conventional
CSI feedback reporting mechanisms for payload size of 128 bits

| | SGCS | SGCE | Overhead |
|---|---|---|---|
| CSI Feedback Reporting Scheme | (layer #1) | (layer #2) | (bits) |
| Baseline: TSF with 128 bits overhead | 0.80 | 0.70 | 128 |
| Proposed: TSF backbone with | 0.88 | 0.82 | 128 |
| 256 bits. −(Threshold 1, | | | |
| Threshold 2) = (−4.5, −4.5). | | | |
| Proposed: TSF backbone with | 0.80 | 0.70 | 64 |
| 256 bits −(Threshold 1, | | | |
| Threshold 2) = (−3.5, −3) | | | |

Table 3 depicts an example performance/overhead comparison between the proposed and conventional CSI feedback reporting mechanisms for payload size of 256 bits. Table 2 presents the SGCS performance of the first and second layers along with the resulting overhead for the CSI feedback reporting scheme and the (e.g., conventional) AI/ML-based TSF CSI compression scheme for payload size of 256 bits. When the payload size is 256 bits, and when the first and second configured thresholds are equal to −5.5 and −4.5 (in the log 10 scale), respectively, the CSI feedback reporting scheme may provide 2.27% and 3.65% SGCS gain for the first and second layers, respectively, with the same CSI feedback overhead of 256 bits compared to (e.g., conventional) AI/ML-based TSF CSI compression scheme. For example, SGCS gain of layer 1 may be calculated as (0.90−0.88)/0.88*100=2.27%. For example, SGCE gain of layer 2 may be calculated as (0.85−0.82)/0.82=3.65%. When the first and second configured thresholds are equal to −4.5 (in the log 10 scale), respectively, the CSI feedback reporting scheme may achieve the same SGCS performance for both layers but with 50% overhead reduction compared to conventional AI/ML-based TSF CSI compression scheme. For example, SGCS in layer 1 may remain 0.88, and SGCE in layer 2 may remain 0.82, but the overhead (bits) may be reduced from 256 to 128.

TABLE 3
Performance/Overhead Comparison between proposed and conventional
CSI feedback reporting mechanisms for payload size of 128 bits

| | SGCS | SGCE | Overhead |
|---|---|---|---|
| CSI Feedback Reporting Scheme | (layer #1) | (layer #2) | (bits) |
| Baseline: TSF with 256 bits overhead | 0.88 | 0.82 | 256 |
| Proposed: TSF backbone with | 0.90 | 0.85 | 256 |
| 256 bits −(Threshold 1, | | | |
| Threshold 2) = (−5.5, −4.5) | | | |
| Proposed: TSF backbone with | 0.88 | 0.82 | 128 |
| 256 bits −(Threshold 1, | | | |
| Threshold 2) = (−4.5, −4.5) | | | |

Based on these results, one can notice that the adaptive filtering technique for CSI feedback reporting (e.g., as described herein) can provide (e.g., significant) performance and/or overhead improvements and/or can provide superior performance-overhead tradeoffs, for example, when compared to (e.g., conventional) AI/ML-based (and/or non-AI/ML) techniques for CSI feedback reporting.

1. A wireless transmit/receive unit (WTRU) comprising:
a processor configured to:
receive configuration information, the configuration information comprising channel state information (CSI) reference signal (RS) (CSI-RS) resource configuration information and CSI feedback reporting configuration information;
determine a downlink (DL) CSI estimate based on one or more CSI-RSs received in accordance with the CSI-RS resource configuration information;
generate a CSI feedback report based on a comparison between the DL CSI estimate and historical DL CSI estimates; and
send the CSI feedback report.

2. The WTRU of claim 1, wherein the processor is configured to generate content of the CSI feedback report based on a difference between the DL CSI estimate and a DL CSI estimate comprised in a sequence of historical DL CSI estimates at the WTRU.

3. The WTRU of claim 1, wherein the CSI feedback report comprises instructions on how to reconstruct the DL CSI estimate at a network node based on historical DL CSI estimates at the network node.

4. The WTRU of claim 1, wherein the comparison comprises a difference between the DL CSI estimate and a DL CSI estimate comprised in a sequence of historical DL CSI estimates at the WTRU; and
wherein, when the difference is lower than a first threshold, the processor is configured to generate the CSI feedback report such that the CSI feedback report comprises a first portion that comprises an indication to the network node to use a previously reconstructed DL CSI estimate comprised in a sequence of historical DL CSI estimates at the network node based on a sequence of historical reconstructed DL CSI estimates at the network node to configure a DL transmission.

5. The WTRU of claim 1, wherein the comparison comprises a first comparison and a second comparison, wherein the first comparison comprises a first difference between the DL CSI estimate and a previous DL CSI estimate comprised in a sequence of historical DL CSI estimates at the WTRU, and wherein the second comparison comprises a second difference between the DL CSI estimate and an output of an adaptive filter applied to a sequence of historical DL CSI estimates at the WTRU; and
wherein, when the first difference is greater than a first threshold, the processor is configured to generate the CSI feedback report such that content of the CSI feedback report is based on the second difference.

6. The WTRU of claim 5, wherein, when the second difference is lower than a second threshold, the processor is configured to generate the CSI feedback report such that the CSI feedback report comprises a first portion and a second portion, wherein the first portion comprises an indication to the network node to apply adaptive filtering to a sequence of historical reconstructed DL CSI estimates at the network node, an index of a structure of the filter in the predefined book, or one or more procedures on how to apply the adaptive filter to the sequence of historical reconstructed DL CSI estimates at the network node, and wherein the second portion comprises parameters of the adaptive filter.

7. The WTRU of claim 5, wherein when the second difference is greater than a second threshold, the processor is further configured to use artificial intelligence (AI)/machine learning (ML)-based CSI feedback reporting techniques or non-AI/ML CSI feedback reporting techniques to generate the CSI feedback report.

8. The WTRU of claim 5, wherein the processor is further configured to determine a structure and one or more parameters of the adaptive filter to minimize a measured difference between the DL CSI estimate and a sequence of historical DL CSI estimates at the WTRU associated with the adaptive filter.

9. The WTRU of claim 1, wherein the processor is configured to:
receive, via downlink control information (DCI) or a medium access control (MAC) control element (CE), activation information, wherein the activation information comprises one or more of a size of a time window, a length of a sequence of historical DL CSI estimates at the WTRU, or one or more thresholds to trigger an adaptive filter parameter update; and
wherein the processor is configured to generate the CSI feedback report based on the activation information.

10. The WTRU of claim 1, wherein the CSI feedback reporting configuration information comprises a CSI-RS configuration type, and wherein the processor is configured to generate the CSI feedback report based on the CSI-RS configuration type.

11. A method implemented in a wireless transmit/receive unit (WTRU), the method comprising:
receiving configuration information, the configuration information comprising channel state information (CSI) reference signal (RS) (CSI-RS) resource configuration information and CSI feedback reporting configuration information;
determining a downlink (DL) CSI estimate based on one or more CSI-RSs received in accordance with the CSI-RS resource configuration information;
generating a CSI feedback report based on a comparison between the DL CSI estimate and historical DL CSI estimates; and
sending the CSI feedback report.

12. The method of claim 11, wherein the CSI feedback report is generated based on a difference between the DL CSI estimate and a DL CSI estimate included in a sequence of historical DL CSI estimates at the WTRU.

13. The method of claim 11, wherein the CSI feedback report comprises instructions on how to reconstruct the DL CSI estimate at a network node based on historical DL CSI estimates at the network node.

14. The method of claim 11, wherein the comparison comprises a difference between the DL CSI estimate and a previous DL CSI estimate comprised in a sequence of historical DL CSI estimates at the WTRU; and
wherein, when the difference is lower than a first threshold, the CSI feedback report is generated such that the CSI feedback report comprises a first portion that comprises an indication to the network node to use a previously reconstructed DL CSI estimate at the network node based on a sequence of historical reconstructed DL CSI estimates at the network node to configure a DL transmission.

15. The method of claim 11, wherein the comparison comprises a first comparison and a second comparison, wherein the first comparison comprises a first difference between the DL CSI estimate and a DL CSI estimate comprised in a sequence of historical DL CSI estimates at the WTRU, and wherein the second comparison comprises a second difference between the DL CSI estimate and an output of an adaptive filter applied to a sequence of historical DL CSI estimates at the WTRU; and
wherein, when the first difference is greater than a first threshold, the CSI feedback report is generated such that content of the CSI feedback report is based on the second difference.

16. The WTRU of claim 15, wherein, when the second difference is lower than a second threshold, the CSI feedback report is generated such that the CSI feedback report comprises a setup portion and a second portion, wherein the setup portion comprises an indication to the network node to apply adaptive filtering to a sequence of historical reconstructed DL CSI estimates at the network node, an index of the structure of the filter in the predefined book, or one or more procedures on how to apply the adaptive filter to the sequence of historical reconstructed DL CSI estimates at the network node, and wherein the second portion comprises parameters of the adaptive filter.

17. The method of claim 15, wherein, when the second difference is greater than a second threshold, the method further comprising using artificial intelligence (AI)/machine learning (ML)-based CSI feedback reporting techniques or non-AI/ML CSI feedback reporting techniques to generate the CSI feedback report.

18. The method of claim 15, the method further comprising determining a structure and one or more parameters of the adaptive filter to minimize a measured difference between the DL CSI estimate and a sequence of historical DL CSI estimates at the WTRU associated with the adaptive filter.

19. The method of claim 15, the method further comprising:
receiving, via downlink control information (DCI) or a medium access control (MAC) control element (CE), activation information, wherein the activation information comprises one or more of a size of a time window, a length of a sequence of historical DL CSI estimates at the WTRU, or one or more thresholds to trigger an adaptive filter parameter update; and
wherein the CSI feedback report is generated based on the activation information.

20. The method of claim 11, wherein the CSI feedback reporting configuration information comprises a CSI-RS configuration type, and wherein the CSI feedback report is generated based on the CSI-RS configuration type.
